(19) United States
(12) Patent Application Publication
(10) Pub. No.: US 2021/0129364 A1
(43) Pub. Date: May 6, 2021

(54) GUARD FOR HAIR REMOVAL DEVICE

(71) Applicant: Church & Dwight Co., Inc., Princeton, NJ (US)

(72) Inventor: Eric Langberg, Milford, PA (US)

(73) Assignee: Church & Dwight Co., Inc., Princeton, NJ (US)

(21) Appl. No.: 17/090,319

(22) Filed: Nov. 5, 2020

Related U.S. Application Data
(60) Provisional application No. 62/930,954, filed on Nov. 5, 2019.

(51) Int. Cl. B26B 21/40

(52) U.S. Cl. CPC B26B 21/4018; B26B 21/4031

(57) ABSTRACT

A guard for a hair removal device is disclosed and includes opposing first and second lateral end members each defining a lateral surface extending between first and second lateral ends; at least one longitudinally-extending member arranged between the opposing first and second lateral end members; and a retaining element arranged on the opposing first and second lateral end members or the at least one longitudinally-extending member to removably retain the guard about a portion of a blade of the hair removal device.

### CROSS-REFERENCE TO RELATED APPLICATIONS

This application claims priority to U.S. Provisional Application No. 62/930,954, filed Nov. 5, 2019, and entitled, “GUARD FOR HAIR REMOVAL DEVICE,” which application is incorporated by reference in its entirety herein.

### FIELD OF THE DISCLOSURE

The present disclosure relates to a guard for a hair removal device. More particularly the present disclosure relates to a guard retained about a portion of a blade of a hair removal device in order to prevent pinching of the skin.

### BACKGROUND

Hair removal devices (such as, for example, electric shavers or trimmers) typically have two blade elements: a fixed blade with a series of alternating slots and protrusions forming teeth and a moving blade. Each slot of the fixed blade may have an outer end, an inner end, and two side walls, with the outer end forming an opening for accepting one or more filaments (i.e., material slender enough and long enough to be received within a slot of the fixed blade). The length of each side wall is generally defined by the distance between the inner end and the outer end thereof. The moving blade may include a series of teeth, which may have the same spacing and shape as the teeth on the fixed blade, or may be a different shape or spacing. Each tooth on the moving blade may have a cutting edge and the teeth may be arranged to extend past the inner end of each associated slot toward the outer end of thereof.

In use, a contact surface of the fixed blade is brought into contact with a contact surface (e.g., a user's skin). As the fixed blade is slid along the contact surface, any filaments (e.g., hair) protruding from the contact surface are guided into the slots. The teeth of the moving blade may then reciprocate across the slots in the fixed blade and any filaments protruding into the slots are sheared by being trapped between cutting edges of the moving blade and the side walls of the slots of the fixed blade. However, in some instances, as illustrated in FIG. 1 showing a hair removal device 100 of the prior art, a contact surface can become trapped in the slots of the fixed blade so that the contact surface snags on the cutting surface of the moving blade, such as, for example, a user's skin. The called-out portion in FIG. 1 illustrates the propensity for skin to enter slots in the fixed blade and contact the moving blade. This can cause momentary discomfort, which can be avoided if the blade does not directly contact the cutting surface.

Accordingly, there exists a need for a guard for a hair removal device that addresses or solves at least the issues mentioned herein.

### BRIEF SUMMARY OF THE DISCLOSURE

The present disclosure relates to a guard for a hair removal device which advantageously reduces the problems associated with conventional hair removal devices.

In some example embodiments, a guard for a hair removal device comprises opposing first and second lateral end members each defining a lateral surface extending between first and second lateral ends; at least one longitudinally-extending member arranged between the opposing first and second lateral end members; and a retaining element arranged on the opposing first and second lateral end members or the at least one longitudinally-extending member to removably retain the guard about a portion of a blade of the hair removal device. Such guard may be further defined by any one or more of the following statements, which may be combined in any number and order.

The at least one longitudinally-extending member can comprise a longitudinally-extending central member extending from a midpoint of the lateral surface of the first lateral end member to a midpoint of the lateral surface of the second lateral end member so as to be adjacent to a top surface of the portion of the blade of the hair removal device, the midpoints of the first and second lateral end members being defined between the respective first and second lateral ends thereof.

The first and second lateral ends of each of the opposing first and second lateral end members can extend down from the respective lateral surface thereof.

Each of the first and second lateral ends of each of the opposing first and second lateral end members can extend down from the respective lateral surface at a substantially 90-degree (90°) angle.

Each of the first and second lateral ends of each of the opposing first and second lateral end members can extend down from the respective lateral surface at an angle of about 10 degrees (10°) to about 30 degrees (30°).

The at least one longitudinally-extending member further can comprise first and second longitudinally-extending side members arranged between the opposing first and second lateral end members and on either side of the longitudinally-extending central member such that the first longitudinally-extending side member can be arranged between the first lateral end of the first lateral end member and the second lateral end member and the second longitudinally-extending side member is arranged between the second lateral end of the first lateral end member and the second lateral end member.

The guard further can comprise a plurality of spaced-apart teeth arranged on each of the first and second longitudinally-extending side members.

The longitudinally-extending central member can define a longitudinal surface offset from the lateral surfaces of the first and second lateral end members, such that the longitudinal surface and the lateral surfaces can be substantially non-coplanar or fully non-coplanar.

The longitudinally-extending central member can define a longitudinal surface co-planar with the lateral surfaces of the first and second lateral end members.

The opposing first and second lateral end members each can include a rear portion extending down from the lateral surface thereof and between the first and second lateral ends.

The retaining element can comprise: a flexible tab defined on the rear portion and arranged to removably engage a corresponding depression in a blade assembly including the blade, and an opening defined on the lateral surface of each of the opposing first and second lateral end members, the opening being aligned with a corresponding protrusion on the blade assembly, wherein the flexible tab and the opening retain the guard about the portion of the blade of the hair removal device.

The at least one longitudinally-extending member can comprise first and second longitudinally-extending side members arranged between the opposing first and second lateral end members such that the first longitudinally-extending side member is arranged between the first lateral ends of the first lateral end member and the second lateral end member and the second longitudinally-extending side member is arranged between the second lateral ends of the first lateral end member and the second lateral end member.

The guard further can comprise a plurality of spaced-apart teeth arranged on each of the first and second longitudinally-extending side members.

The retaining element can define a rib arranged on the first and second lateral ends of each of the first and second lateral end members and that engages a bottom surface of the blade and retains the guard about the portion of the blade of the hair removal device.

In further embodiments, the present disclosure can relate to a hair removal device system comprising: a hair removal device comprising a blade; and a guard retainable about a portion of the blade and comprising: opposing first and second lateral end members each defining a lateral surface extending between first and second lateral ends; at least one longitudinally-extending member arranged between the opposing first and second lateral end members; and a retaining element arranged on the opposing first and second lateral end members or the at least one longitudinally-extending member to removably retain the guard about a portion of the blade of the hair removal device. Such system may be further defined by any one or more of the following statements, which may be combined in any number and order

The at least one longitudinally-extending member of the guard can comprise a longitudinally-extending central member extending from a midpoint of the lateral surface of the first lateral end member to a midpoint of the lateral surface of the second lateral end member so as to be adjacent to a top surface of the portion of the blade of the hair removal device, the midpoints of the first and second lateral end members being defined between the respective first and second lateral ends thereof.

Each of the first and second lateral ends of each of the opposing first and second lateral end members of the guard can extend down from the respective lateral surface thereof.

The at least one longitudinally-extending member of the guard further can comprise first and second longitudinally-extending side members arranged between the opposing first and second lateral end members and on either side of the longitudinally-extending central member such that the first longitudinally-extending side member is arranged between the first lateral ends of the first lateral end member and the second lateral end member and the second longitudinally-extending side member is arranged between the second lateral ends of the first lateral end member and the second lateral end member.

The guard further can comprise a plurality of spaced-apart teeth arranged on each of the first and second longitudinally-extending side members.

The at least one longitudinally-extending member of the guard can comprise first and second longitudinally-extending side members arranged between the opposing first and second lateral end members such that the first longitudinally-extending side member is arranged between the first lateral ends of the first lateral end member and the second lateral end member and the second longitudinally-extending side member is arranged between the second lateral ends of the first lateral end member and the second lateral end member.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific aspect description or claim herein. This disclosure is intended to be read holistically such that any separable features or elements of the disclosure, in any of its aspects, should be viewed as intended to be combinable, unless the context of the disclosure clearly dictates otherwise.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a hair removal device according to the prior art;

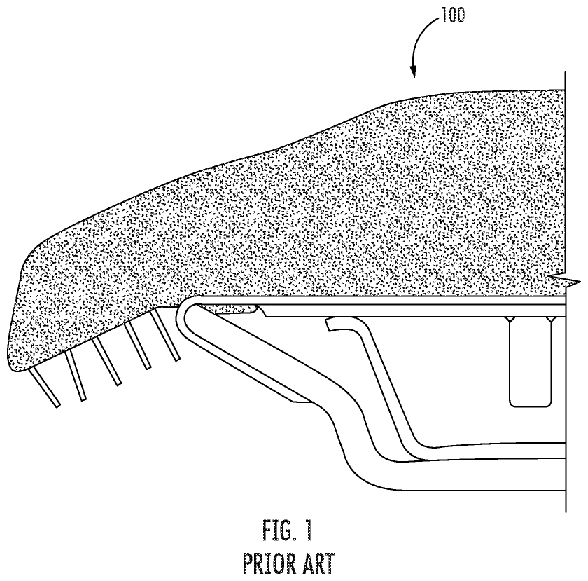

FIG. 2 illustrates a cross-sectional view of a hair removal device including a guard according to some example embodiments of the present disclosure;

FIGS. 3A-3H illustrate different example cross-sections of a longitudinally-extending central member according to some example embodiments of the present disclosure;

FIG. 4 illustrates a perspective view of a first example embodiment of a guard for a hair removal device according to some example embodiments of the present disclosure;

FIG. 5 illustrates a perspective view of a second example embodiment of a guard for a hair removal device according to some example embodiments of the present disclosure;

FIGS. 6A-6C illustrate perspective views of a third example embodiment of a guard for a hair removal device according to some example embodiments of the present disclosure;

FIGS. 7A-7B illustrates a perspective view of a fourth example embodiment of a guard for a hair removal device according to some example embodiments of the present disclosure;

FIG. 8 illustrates a perspective view of a fifth example embodiment of a guard for a hair removal device according to some example embodiments of the present disclosure;

FIG. 9 illustrates a perspective view of a sixth example embodiment of a guard for a hair removal device according to some example embodiments of the present disclosure; and

FIGS. 10A-10C illustrates a perspective view of a seventh example embodiment of a guard for a hair removal device according to some example embodiments of the present disclosure.

### DETAILED DESCRIPTION OF PREFERRED EMBODIMENTS

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural variations unless the context clearly dictates otherwise.

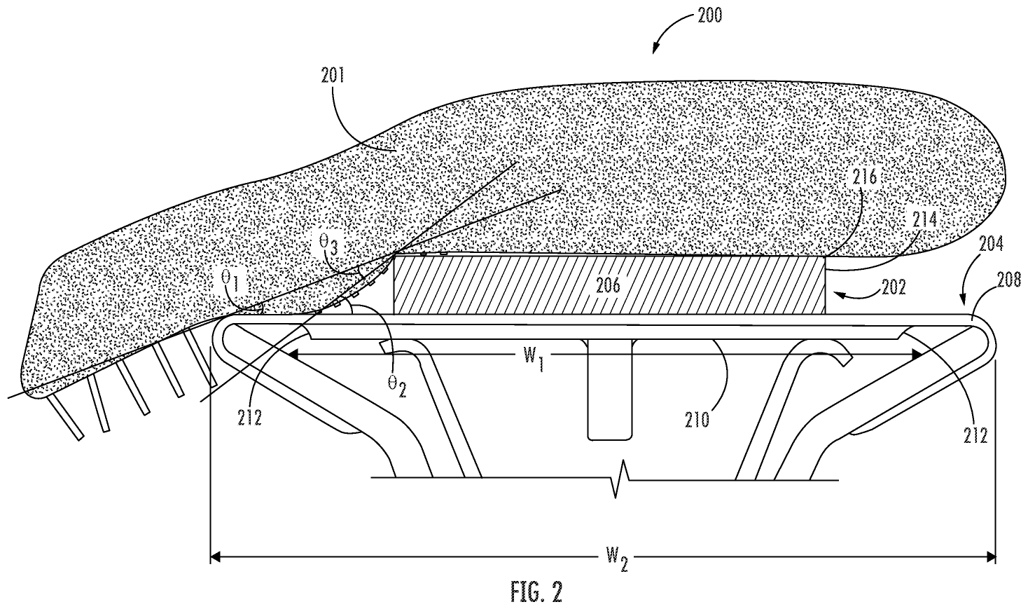

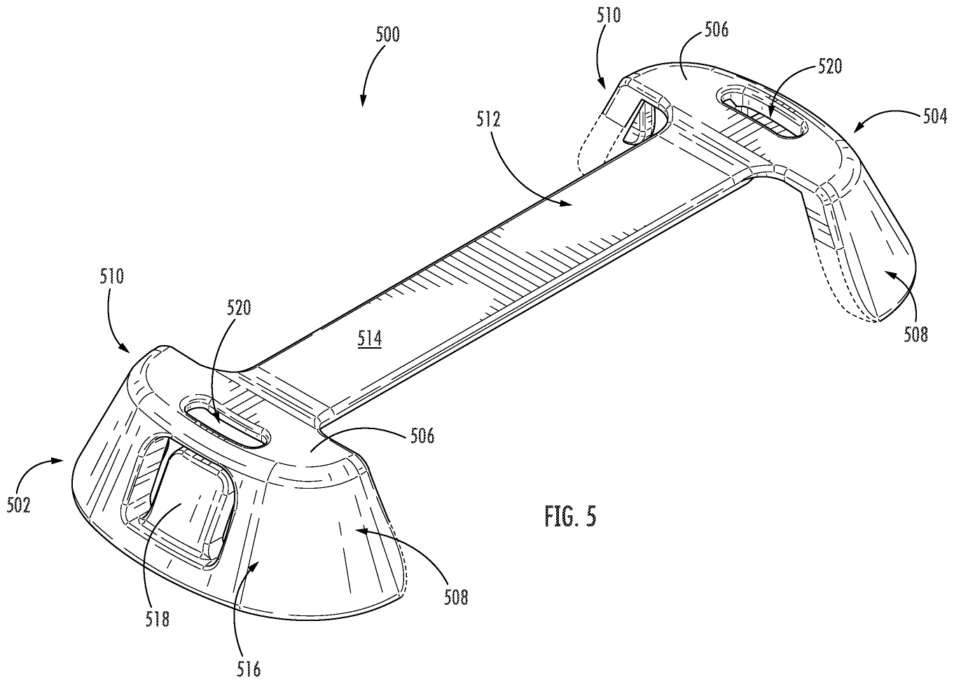

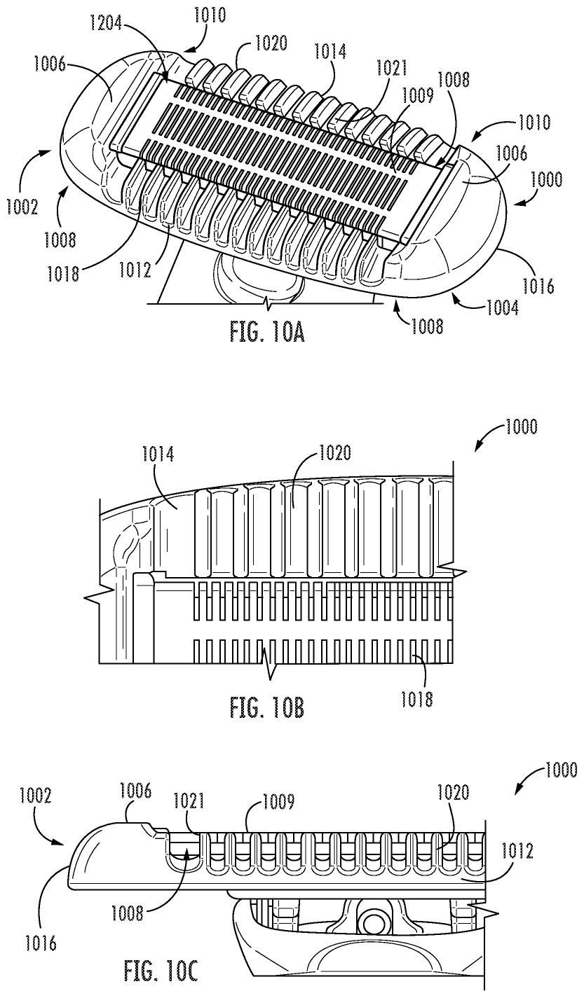

A guard for a hair removal device as disclosed herein may be utilized with any type of hair removal device having a blade. For example, the guard may be utilized with a hair trimming apparatus such as that disclosed in U.S. patent application Ser. No. 15/932,888, which is incorporated by reference in its entirety. For example, FIG. 2 illustrates a cross-sectional view of a hair removal device including a guard, generally designated as 200, according to some example embodiments of the present disclosure. For example, the hair removal device 200 includes the guard 202, which can be mounted to or otherwise arranged relative to a blade assembly 204. In some embodiments, the guard 202 may comprise, at a minimum, a longitudinally-extending central member 206. In such embodiments, the longitudinally-extending central member 206 may be attachable to the blade assembly 204. Alternatively, the longitudinally-extending central member 206 may be integral with the blade assembly 204. For example, the longitudinally-extending central member 206 may be integrally formed with an element of the blade assembly 204. In another example, the longitudinally-extending central member 206 may be substantially permanently attached to an element of the blade assembly. For example, the longitudinally-extending central member 206 may be glued, welded, or otherwise attached to the blade assembly 204. If desired, however, the longitudinally-extending central member 206 may be included with the blade assembly but may be removable therefrom such that an alternative embodiment of the guard 202 may be combined with the blade assembly 204. The longitudinally-extending central member 206 may be removably attached to the blade assembly 204 utilizing attachment components as otherwise described herein. For example, attachment elements as described in relation to FIG. 5 may be combined in any manner with the longitudinally-extending central member 206. As illustrated in FIG. 2, the longitudinally-extending central member 206 is combined with the blade assembly 204 as the guard 202, and further embodiments of the guard (see, e.g., FIGS. 10A-10C) may be combinable therewith.

In further embodiments, the guard 202 as disclosed herein may generally include, for example, opposing first and second lateral end members each defining a lateral surface extending between first and second lateral ends; at least one longitudinally-extending member arranged between the opposing first and second lateral end members so that the opposing first and second lateral end members are substantially parallel to one another; and a retaining element arranged on the opposing first and second lateral end members or the at least one longitudinally-extending member to removably retain the guard about a portion of a blade of the hair removal device.

A width of the longitudinally-extending central member 206 may be determined by an overall width of the corresponding blade assembly 204. For example, where the hair removal device is a double-edge electric shaver comprising a front fixed blade 208 with two outer edges and a moving rear blade 210 with two cutting edges 212, the guard 202 is centered between and extending outwardly toward the cutting edges 212, to outer walls 214 of the longitudinally-extending central member 206.

As illustrated in FIG. 2, the longitudinally-extending central member 206 is configured to create a tangent angle θ₁ between each outer edge of the front fixed blade 208 and a top corner 216 of each outer wall 214 of the guard 202. The tangent angle θ₁ may be in the range of about 10° to about 55°; however, the tangent angle θ₁ may also depend on a width w₁ of the moving blade 210 in relation to a width w₂ of the fixed blade 208. A second tangent angle θ₂ is formed between the end of the cutting edges 212 and the top corner 216 of each outer wall 214 of the guard 202. The second tangent angle θ₂ is in the range from about 15° to about 65°. The combination of θ₁ and θ₂ create a ratio angle θ3 which is the angle created by the outer edge of the front fixed blade 208 and the cutting edge 212 of the moving rear blade 210 with the top corner 216 of the longitudinally-extending central member 206 as the apex. The ratio angle θ₃ is in the range of about 5° to about 45°. In one example embodiment, the ratio angle θ₃ is maintained in a range of about 7° to about 25°. Performance may also be affected by the blade construction with regard to a width of each cutting slot of the fixed blade 208 in relation to a width of each tooth between adjacent cutting slots combined with a thickness of the fixed blade 208. The wider the cutting slot, the closer the outer wall 214 of the longitudinally-extending central member 206 is to the cutting edge 212.

The guard 200 may generally be composed of a generally rigid, but durable, material that is configured to be removable from about the portion of the blade of the hair removal device. For example, the guard 200 may be composed of a polymer, a metal, a wood, a ceramic, a composite of more than one material, a combination thereof, and the like. In this manner, when the hair removal device 200 including the guard 202 is moved along or across a contact surface (e.g., a user's skin 201) such that the hair removal device 200 including the guard 202 is in direct contact with the contact surface, the guard 202 pushes the contact surface (e.g., the outer surface of the skin 201) away from the blades 208, 210 of the hair removal device 200, so that the hair is positioned to be cut by the hair removal device 200, but the skin is not snagged or otherwise trapped, pinched, and/or cut by the blades 208, 210. As shown in FIG. 2, the guard 202 causes skin 201 to life away from the front surface of the front fixed blade 208 before the skin can interact with the moving blade 210.

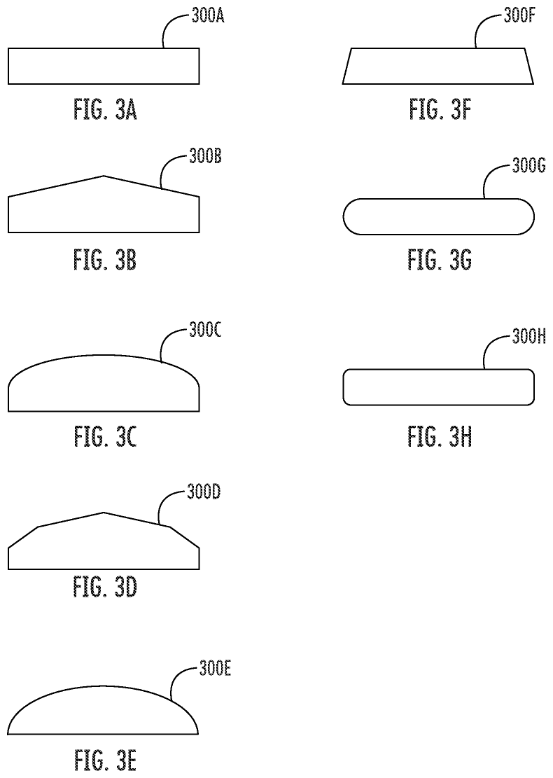

FIGS. 3A-3H illustrate different example cross-sections of a longitudinally-extending central member according to some example embodiments of the present disclosure. For example, in FIG. 3A, a longitudinally-extending central member 300A defines a rectangular cross-section. In another example, in FIG. 3B, a longitudinally-extending central member 300B defines a pentagonal cross-section. In another example, in FIG. 3C, a longitudinally-extending central member 300C defines a cross-section with a rectangular bottom surface and a convex top surface. In another example, in FIG. 3D, a longitudinally-extending central member 300D defines a hexagonal cross-section. In another example, in FIG. 3E, a longitudinally-extending central member 300E defines a hemispherical cross-section. In another example, in FIG. 3F, a longitudinally-extending central member 300F defines a trapezoidal cross-section. In another example, in FIG. 3G, a longitudinally-extending central member 300G defines an ovular cross-section. In another example, in FIG. 3H, a longitudinally-extending central member 300H defines a rectangular cross-section with rounded corners. However, the cross-sections in FIGS. 3A-3H are merely for illustrative purposes only and any other polygonal shape is contemplated by this disclosure herein.

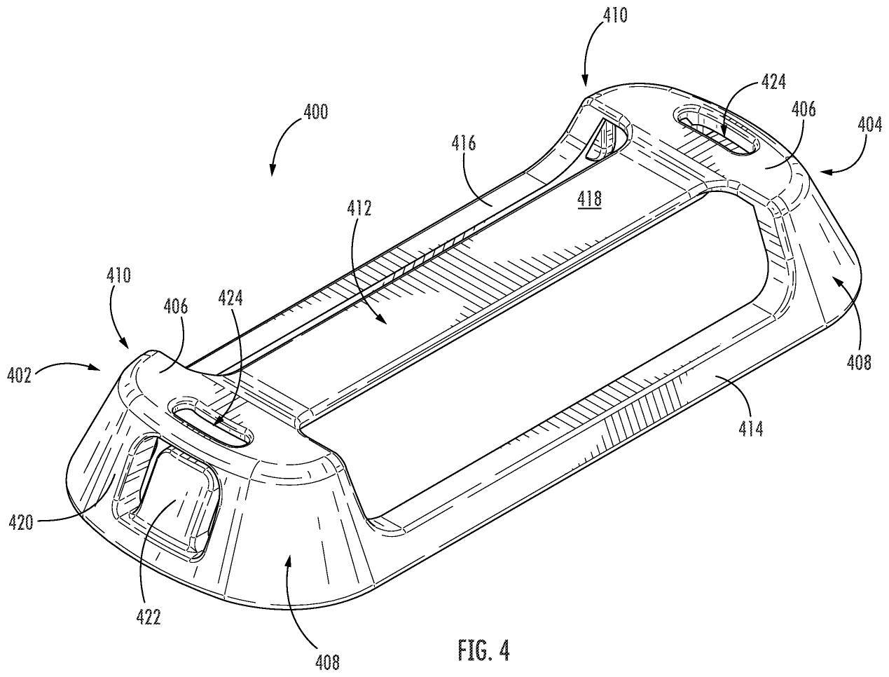

FIG. 4 illustrates a first example embodiment of a guard for a hair removal device, the guard being generally designated reference numeral 400. The guard 400 may include opposing first and second lateral end members 402, 404 each defining a lateral surface 406 extending between first and second lateral ends 408, 410. At least one longitudinally-extending member may be arranged between the opposing first and second lateral end members 402, 404. As illustrated in FIG. 4, the at least one longitudinally-extending member comprises a longitudinally-extending central member 412 extending from a midpoint of the lateral surface 406 of the first lateral end member 402 to a midpoint of the lateral surface 406 of the second lateral end member 404 so as to be adjacent to a top surface of a portion of a blade of a hair removal device. In this manner, the midpoints of the first and second lateral end members 402, 404 are defined between the respective first and second lateral ends 408, 410 thereof.

Further, the at least one longitudinally-extending member may comprise first and second longitudinally-extending side members 414, 416 arranged between the opposing first and second lateral end members 402, 404 and on either side of the longitudinally-extending central member 412 such that the first longitudinally-extending side member 414 is arranged between the first lateral ends 408 of the first lateral end member 402 and the second lateral end member 404 and the second longitudinally-extending side member 416 is arranged between the second lateral ends 410 of the first lateral end member 402 and the second lateral end member 404. In some embodiments, the longitudinally-extending central member 412 may define a longitudinal surface 418 that is substantially coplanar with the lateral surfaces 406 of the first and second lateral end members 402, 404. In other embodiments, the longitudinally-extending central member 412 may define a longitudinal surface 418 that is offset from the lateral surfaces 406 of the first and second lateral end members 402, 404, such that the longitudinal surface 418 and the lateral surfaces 406 are substantially non-coplanar. To this end, substantially non-coplanar can indicate that the longitudinal surface 418 is above or below a plane defined by the lateral surfaces 406 by at least 0.2 mm, at least 0.5 mm, or at least 1 mm. In such embodiments, the longitudinal surface 418 and the lateral surfaces 406 may be non-coplanar in that the longitudinal surface 418 is above or below a plane defined by the lateral surfaces 406 by about 0.5 mm to about 4 mm or about 1 mm to about 3 mm. Such “non-coplanar” configuration may be desirable, for example to more specifically raise the skin away from the blade system at the lateral end members 402, 404 relative to the longitudinally-extending central member 412 in order to more particularly minimizing snagging or pinching of the skin at the lateral ends or corners of the blade system, which is a common area in movable blade systems for such snagging or pinching to occur.

As illustrated in FIG. 4, each of the first and second lateral ends 408, 410 of each of the opposing first and second lateral end members 402, 404 extends down from the respective lateral surface 406 thereof at an angle creating sloped surfaces of the first and second lateral ends 408, 410, resulting in a generally trapezoidal side profile. The sloped surfaces are employed to provide additional clearance for first and second longitudinally-extending side members 414, 416 during articulation of a blade (not shown) to which the guard 400 is attached. For example, the angle from top to bottom may be about 10° to about 30° or about 15° to about 25° (e.g., about) 22°, but the range may vary more significantly, such as in the range of about 0° to about 45°. Further, the opposing first and second lateral end members 402, 404 may each include a rear portion 420 extending down from the lateral surface thereof and between the first and second lateral ends. In this manner, the lateral end members 402, 404 are arranged to substantially cover an end portion of the blade, while the longitudinally-extending central member 412 is arranged to cover a longitudinal, central portion of the blade.

The guard 400 may further comprise a retaining element arranged on the opposing first and second lateral end members 402, 404 to removably retain the guard 400 about a portion of a blade of the hair removal device. The retaining element may be any type of member capable of retaining the guard 400. For example, the retaining element may comprise a flexible tab 422 defined on the rear portion 420, which is arranged to removably engage a corresponding depression in a blade assembly including the blade so as to retain the guard 400 about the portion of the blade. Application of force to the guard 400 may result in removal of the flexible tab 422 from the corresponding depression. In addition to or instead of, the retaining element may include an opening 424 defined on the lateral surface 406 of the opposing first and second lateral end members 402, 404. The opening 424 may be aligned with a corresponding protrusion on the blade assembly. The flexible tab 422 and the opening 424 are thus arranged to retain the guard 400 about the portion of the blade of the hair removal device.

FIG. 5 illustrates a second example embodiment of a guard for a hair removal device, the guard being generally designated reference numeral 500. The guard 500 may include opposing first and second lateral end members 502, 504 each defining a lateral surface 506 extending between first and second lateral ends 508, 510. At least one longitudinally-extending member may be arranged between the opposing first and second lateral end members 502, 504. As illustrated in FIG. 5, the at least one longitudinally-extending member comprises a longitudinally-extending central member 512 extending from a midpoint of the lateral surface 506 of the first lateral end member 502 to a midpoint of the lateral surface 506 of the second lateral end member 504 so as to be adjacent to a top surface of a portion of a blade of a hair removal device. In this manner, the midpoints of the first and second lateral end members 502, 504 are defined between the respective first and second lateral ends 508, 510 thereof. The longitudinally-extending central member 512 may define a longitudinal surface 514 offset from the lateral surfaces 506 of the first and second lateral end members 502, 504, such that the longitudinal surface 514 and the lateral surfaces 506 are substantially non-coplanar, which can be defined as otherwise discussed above in relation to FIG. 4.

As illustrated in FIG. 5, each of the first and second lateral ends 508, 510 of each of the opposing first and second lateral end members 502, 504 extends down from the respective lateral surface 506 thereof at an angle of about 10° to about 30° or about 15° to about 25° (e.g., about) 22°, but the range may vary more significantly, such as in the range of about 0° to about 45°. Further, the opposing first and second lateral end members 502, 504 may each include a rear portion 516 extending down from the lateral surface thereof and between the first and second lateral ends. In this manner, the lateral end members 502, 504 are arranged to substantially cover an end portion of the blade, while the longitudinally-extending central member 512 is arranged to cover a longitudinal, central portion of the blade.

The guard 500 may further comprise a retaining element arranged on the opposing first and second lateral end members 502, 504 to removably retain the guard 500 about a portion of a blade of the hair removal device. The retaining element may be any type of member capable of retaining the guard 500. For example, the retaining element may comprise a flexible tab 518 defined on the rear portion 516, which is arranged to removably engage a corresponding depression in a blade assembly including the blade so as to retain the guard 500 about the portion of the blade. Application of force to the guard 500 may result in removal of the flexible tab 518 from the corresponding depression. In addition to, or instead of, the retaining element may comprise an opening 520 defined on the lateral surface 506 of the opposing first and second lateral end members 502, 504. The opening 520 may be aligned with a corresponding protrusion on the blade assembly. The flexible tab 518 and the opening 520 are thus arranged to retain the guard 500 about the portion of the blade of the hair removal device.

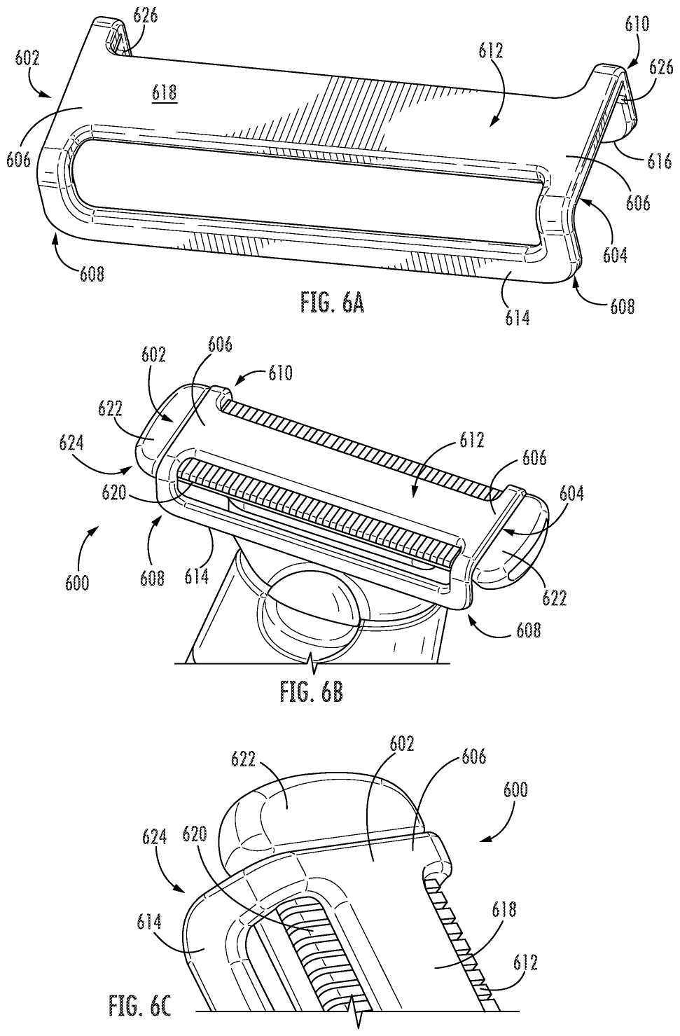

FIGS. 6A-6C illustrate a third example embodiment of a guard for a hair removal device, the guard being generally designated reference numeral 600. The guard 600 may include opposing first and second lateral end members 602, 604 each defining a lateral surface 606 extending between first and second lateral ends 608, 610. At least one longitudinally-extending member may be arranged between the opposing first and second lateral end members 602, 604 so that the opposing first and second lateral end members 602, 604 are substantially parallel to one another. As illustrated in FIGS. 6A-6C, the at least one longitudinally-extending member comprises a longitudinally-extending central member 612 extending from a midpoint of the lateral surface 606 of the first lateral end member 602 to a midpoint of the lateral surface 606 of the second lateral end member 604 so as to be adjacent to a top surface of a portion of a blade of a hair removal device. In this manner, the midpoints of the first and second lateral end members 602, 604 are defined between the respective first and second lateral ends 608, 610 thereof.

Further, the at least one longitudinally-extending member may comprise first and second longitudinally-extending side members 614, 616 arranged between the opposing first and second lateral end members 602, 604 and on either side of the longitudinally-extending central member 612 such that the first longitudinally-extending side member 614 is arranged between the first lateral ends 608 of the first lateral end member 602 and the second lateral end member 604 and the second longitudinally-extending side member 616 is arranged between the second lateral ends 610 of the first lateral end member 602 and the second lateral end member 604. The longitudinally-extending central member 612 may define a longitudinal surface 618 that is substantially co-planar with the lateral surfaces 606 of the first and second lateral end members 602, 604. Substantially co-planar can indicate that the longitudinal surface 618 and the lateral surfaces 606 of the first and second lateral end members 602, 604 are exactly within the same plane, or the longitudinal surface 618 is above or below the lateral surfaces 606 of the first and second lateral end members 602, 604 by no more than 0.5 mm, 0.2 mm, or 0.1 mm.

As illustrated in FIGS. 6A-6C, each of the first and second lateral ends 608, 610 of each of the opposing first and second lateral end members 602, 604 extends down from the respective lateral surface 606 thereof at a substantially 90-degree (90°) angle. In this manner, the lateral end members 602, 604 are arranged to cover a portion of a blade 620, inset from a blade bracket 622 of a blade assembly 624 including the blade 620 and the blade bracket 622, while the longitudinally-extending central member 612 is arranged to cover a longitudinal, central portion of the blade 620. A substantially 90-degree angle may vary above or below the noted angle by no more than 5%, no more than 3%, no more than 2%, or no more than 1%.

The guard 600 may further comprise a retaining element 626 arranged on the opposing first and second lateral end members 602, 604 to removably retain the guard 600 about a portion of a blade of the hair removal device. As illustrated in FIG. 6C, the retaining element 626 may define a rib arranged on the first and second lateral ends 608, 610 of each of the first and second lateral end members 602, 604 and that engages a bottom surface of the blade 620 and retains the guard 600 about the portion of the blade 620 of the hair removal device.

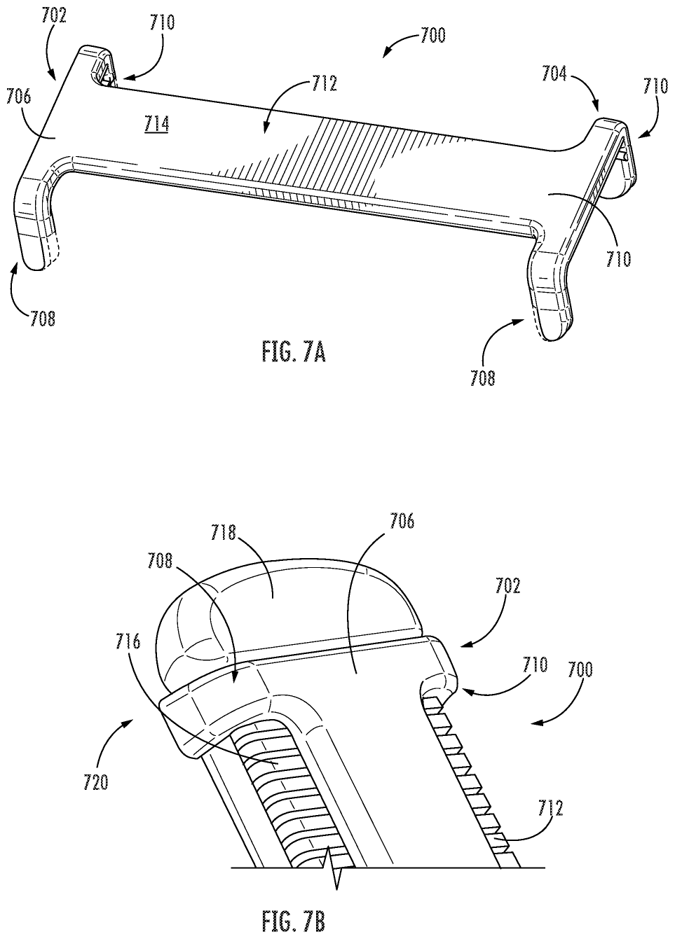

FIGS. 7A-7B illustrates a fourth example embodiment of a guard for a hair removal device, the guard being generally designated reference numeral 700. The guard 700 may include opposing first and second lateral end members 702, 704 each defining a lateral surface 706 extending between first and second lateral ends 708, 710. At least one longitudinally-extending member may be arranged between the opposing first and second lateral end members 702, 704 so that the opposing first and second lateral end members 702, 704 are substantially parallel to one another. As illustrated in FIG. 7A, the at least one longitudinally-extending member comprises a longitudinally-extending central member 712 extending from a midpoint of the lateral surface 706 of the first lateral end member 702 to a midpoint of the lateral surface 706 of the second lateral end member 704 so as to be adjacent to a top surface of a portion of a blade of a hair removal device. In this manner, the midpoints of the first and second lateral end members 702, 704 are defined between the respective first and second lateral ends 708, 710 thereof. The longitudinally-extending central member 712 may define a longitudinal surface 714 that is substantially co-planar with the lateral surfaces 706 of the first and second lateral end members 702, 704, wherein substantially co-planar is as otherwise defined above.

As illustrated in FIG. 7B, each of the first and second lateral ends 708, 710 of each of the opposing first and second lateral end members 702, 704 extends down from the respective lateral surface 706 thereof at a substantially 90-degree (90°) angle. In this manner, the lateral end members 702, 704 are arranged to cover a portion of a blade 716, inset from a blade bracket 718 of a blade assembly 720 including the blade 716 and the blade bracket 718, while the longitudinally-extending central member 712 is arranged to cover a longitudinal, central portion of the blade 716. A substantially 90-degree angle can be as otherwise described above.

The guard 700 may further comprise a retaining element arranged on the opposing first and second lateral end members 702, 704 to removably retain the guard 700 about a portion of a blade of the hair removal device. The retaining element may be any type of member capable of retaining the guard 700. Although not illustrated in FIG. 7A or 7B, the retaining element may define a rib arranged on the first and second lateral ends 708, 710 of each of the first and second lateral end members 702, 704 and that engages a bottom surface of the blade 716 and retains the guard 700 about the portion of the blade 716 of the hair removal device.

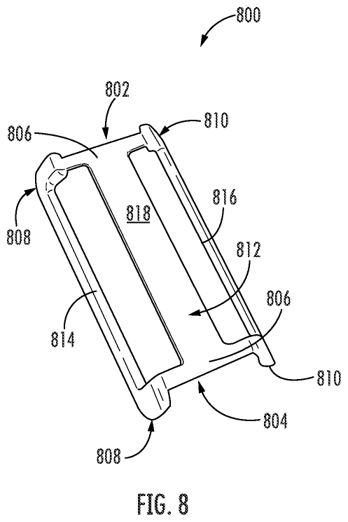

FIG. 8 illustrates a fifth example embodiment of a guard for a hair removal device, the guard being generally designated reference numeral 800. The guard 800 may include opposing first and second lateral end members 802, 804 each defining a lateral surface 806 extending between first and second lateral ends 808, 810. At least one longitudinally-extending member may be arranged between the opposing first and second lateral end members 802, 804 so that the opposing first and second lateral end members 802, 804 are substantially parallel to one another. As illustrated in FIG. 8, the at least one longitudinally-extending member comprises a longitudinally-extending central member 812 extending from a midpoint of the lateral surface 806 of the first lateral end member 802 to a midpoint of the lateral surface 806 of the second lateral end member 804 so as to be adjacent to a top surface of a portion of a blade of a hair removal device. In this manner, the midpoints of the first and second lateral end members 802, 804 are defined between the respective first and second lateral ends 808, 810 thereof.

Further, the at least one longitudinally-extending member may comprise first and second longitudinally-extending side members 814, 816 arranged between the opposing first and second lateral end members 802, 804 and on either side of the longitudinally-extending central member 812 such that the first longitudinally-extending side member 814 is arranged between the first lateral ends 808 of the first lateral end member 802 and the second lateral end member 804 and the second longitudinally-extending side member 816 is arranged between the second lateral ends 810 of the first lateral end member 802 and the second lateral end member 804. The longitudinally-extending central member 812 may define a longitudinal surface 818 that is substantially co-planar with the lateral surfaces 806 of the first and second lateral end members 802, 804. Substantially co-planar can have the same meaning as otherwise described above.

As illustrated in FIG. 8, each of the first and second lateral ends 808, 810 of each of the opposing first and second lateral end members 802, 804 extends down from the respective lateral surface 806 thereof at an angle of about 10° to about 30° or about 15° to about 25° (e.g., about) 22°, but the range may vary more significantly, such as in the range of about 0° to about 45°. In this manner, the lateral end members 802, 804 are arranged to cover a portion of a blade, inset from a blade bracket of a blade assembly including the blade and the blade bracket, while the longitudinally-extending central member 812 is arranged to cover a longitudinal, central portion of the blade.

The guard 800 may further comprise a retaining element arranged on the opposing first and second lateral end members 802, 804 to removably retain the guard 800 about a portion of a blade of the hair removal device. The retaining element may be any type of member capable of retaining the guard 800. Although not illustrated in FIG. 8, the retaining element may define a rib arranged on the first and second lateral ends 808, 810 of each of the first and second lateral end members 802, 804 and that engages a bottom surface of the blade and retains the guard 800 about the portion of the blade of the hair removal device.

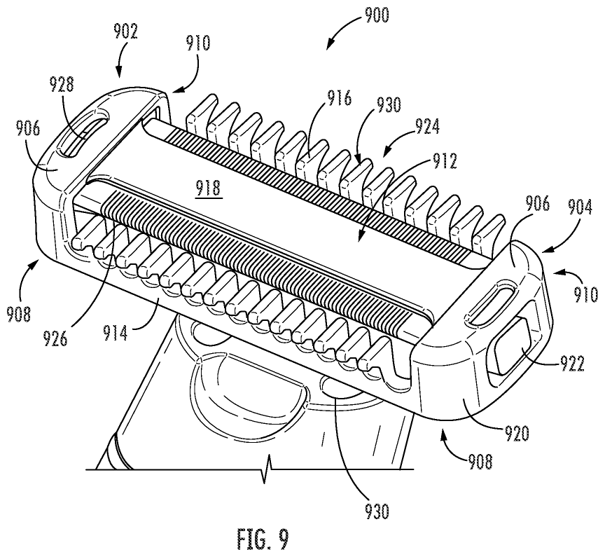

FIG. 9 illustrates a sixth example embodiment of a guard for a hair removal device, the guard being generally designated reference numeral 900. The guard 900 may include opposing first and second lateral end members 902, 904 each defining a lateral surface 906 extending between first and second lateral ends 908, 910. At least one longitudinally-extending member may be arranged between the opposing first and second lateral end members 902, 904. As illustrated in FIG. 9, the at least one longitudinally-extending member comprises a longitudinally-extending central member 912 extending from a midpoint of the lateral surface 906 of the first lateral end member 902 to a midpoint of the lateral surface 906 of the second lateral end member 904 so as to be adjacent to a top surface of a portion of a blade of a hair removal device. In this manner, the midpoints of the first and second lateral end members 902, 904 are defined between the respective first and second lateral ends 908, 910 thereof.

Further, the at least one longitudinally-extending member may comprise first and second longitudinally-extending side members 914, 916 arranged between the opposing first and second lateral end members 902, 904 and on either side of the longitudinally-extending central member 912 such that the first longitudinally-extending side member 914 is arranged between the first lateral ends 908 of the first lateral end member 902 and the second lateral end member 904 and the second longitudinally-extending side member 916 is arranged between the second lateral ends 910 of the first lateral end member 902 and the second lateral end member 904. The longitudinally-extending central member 912 may define a longitudinal surface 918 offset from the lateral surfaces 906 of the first and second lateral end members 902, 904, such that the longitudinal surface 918 and the lateral surfaces 906 are substantially non-coplanar, wherein substantially non-coplanar can have the same meaning as otherwise described above.

As illustrated in FIG. 9, each of the first and second lateral ends 908, 910 of each of the opposing first and second lateral end members 902, 904 extends down from the respective lateral surface 906 thereof at a substantially 90-degree (90°) angle, which can have the same meaning as otherwise described above. Further, the opposing first and second lateral end members 902, 904 may each include a rear portion 920 extending down from the lateral surface thereof and between the first and second lateral ends. In this manner, the lateral end members 902, 904 are arranged to substantially cover an end portion of the blade, while the longitudinally-extending central member 912 is arranged to cover a longitudinal, central portion of the blade.

The guard 900 may further comprise a retaining element arranged on the opposing first and second lateral end members 902, 904 to removably retain the guard 900 about a portion of a blade of the hair removal device. The retaining element may be any type of member capable of retaining the guard 900. For example, the retaining element may include a flexible tab 922 on the rear portion 920, which is arranged to removably engage a corresponding depression in a blade assembly 924 including the blade 926 so as to retain the guard 900 about the portion of the blade 926. Application of force to the guard 900 may result in removal of the flexible tab 922 from the corresponding depression. In addition to, or instead of, the retaining element may also include an opening 928 defined on the lateral surface 906 of the opposing first and second lateral end members 902, 904. The opening 928 may be aligned with a corresponding protrusion on the blade assembly 924. The flexible tab 922 and the opening 928 are thus arranged to retain the guard 900 about the portion of the blade 926 of the hair removal device.

The guard 900 may further comprise a plurality of spaced-apart teeth 930 arranged on each of the first and second longitudinally-extending side members 914, 916. The plurality of spaced-apart teeth 930 may extend upwardly from the side members 914, 916 so as to act as a comb. A height of the plurality of spaced-apart teeth may be about 2 mm to about 4 mm, about 2.5 mm to about 3.5 mm, and preferably about 2.8 millimeters. Spacing between each of the spaced-apart teeth 930 may be about 0.2 mm to about 5 mm, about 0.5 mm to about 4 mm, or about 1 mm to about 3 mm, and the teeth 930 may have a thickness of about 0.3 mm to about 5 mm, about 0.6 mm to about 4 mm, or about 1 mm to about 3 mm. The spaced-apart teeth 930 may have a substantially L-shaped profile, although other profiles are also contemplated.

FIGS. 10A-10C illustrate a seventh example embodiment of a guard for a hair removal device, the guard being generally designated reference numeral 1000. The guard 1000 may include opposing first and second lateral end members 1002, 1004 each defining a lateral surface 1006 extending between first and second lateral ends 1008, 1010. At least one longitudinally-extending member may be arranged between the opposing first and second lateral end members 1002, 1004. As illustrated in FIG. 10A, the at least one longitudinally-extending member may comprise first and second longitudinally-extending side members 1012, 1014 arranged between the opposing first and second lateral end members 1002, 1004 such that the first longitudinally-extending side member 1012 is arranged between the first lateral ends 1008 of the first lateral end member 1002 and the second lateral end member 1004 and the second longitudinally-extending side member 1014 is arranged between the second lateral ends 1010 of the first lateral end member 1002 and the second lateral end member 1004.

As illustrated in FIG. 10A, each of the first and second lateral ends 1008, 1010 of each of the opposing first and second lateral end members 1002, 1004 extends down from the respective lateral surface 1006 thereof at a substantially 90-degree (90°) angle. Further, the opposing first and second lateral end members 1002, 1004 may each include a rear portion 1016 extending down from the lateral surface thereof and between the first and second lateral ends. In this manner, the lateral end members 1002, 1004 are arranged to substantially cover an end portion of a blade 1018.

The guard 1000 may further comprise a retaining element arranged on the opposing first and second lateral end members 1002, 1004 or the at least one longitudinally-extending member 1012, 1014 to removably retain the guard 1000 about a portion of the blade 1018 of the hair removal device. The retaining member may be any type of member capable of retaining the guard 1000. For example, the retaining member may define a rib arranged on the first and second lateral ends 1008, 1010 of each of the first and second lateral end members 1002, 1004 and that engages a bottom surface of the blade 1018 and retains the guard 1000 about the portion of the blade 1018 of the hair removal device.

The guard 1000 may further comprise a plurality of spaced-apart teeth 1020 arranged on each of the first and second longitudinally-extending side members 1012, 1014. The plurality of spaced-apart teeth 1020 may extend upwardly from the side members 1012, 1014 so as to act as a comb. A height of the plurality of spaced-apart teeth 1020 may be about 2 mm to about 4 mm, about 2.5 mm to about 3.5 mm, and preferably about 2.8 millimeters. Spacing between each of the spaced-apart teeth 1020 may be about 0.2 mm to about 5 mm, about 0.5 mm to about 4 mm, or about 1 mm to about 3 mm, and the teeth 1020 may have a thickness of about 0.3 mm to about 5 mm, about 0.6 mm to about 4 mm, or about 1 mm to about 3 mm. The spaced-apart teeth 1020 may have a substantially trapezoidal profile, although other profiles are also contemplated. In some embodiments, the tip surface 1021 of the spaced-apart teeth 1020 may be substantially coplanar with an outer surface 1009 of the front fixed blade 1008 of the blade assembly 1204. Such configuration is evident, for example, in FIG. 10C. In other embodiments, the tip surface 1021 of the spaced-apart teeth 1020 may extend a distance above the outer surface 1009 of the front fixed blade 1008 of the blade assembly 1204, such as a distance of up to 5 mm, up to 4 mm, or up to 2 mm (e.g., about 0.5 mm to about 5 mm or about 1 mm to about 4 mm). Such configuration is evident, for example, in FIG. 10A.

Noticeably absent from the guard 1000 in FIGS. 10A-10C is any longitudinally-extending central member (e.g., element 912 in FIG. 9). The absence of such member may provide benefits in that an improved cutting experience may be obtained an/or an improved cutting experience may be perceived by a user of the device. Nevertheless, in some embodiments, it may be more preferred to utilize embodiments as disclosed herein that do include the longitudinally-extending central member since such member can provide an improved ability to maintain separation of the skin of a user from the cutting blades and thus provide improved prevention of pinching, cutting, or the like to the skin by the blades while still achieving the desired hair cutting performance. Accordingly, in some embodiments, the longitudinally-extending central member (e.g., element 912 in FIG. 9) may be integrally formed with the guard 1000.

In some embodiments, the longitudinally-extending central member, instead of being included with the guard, may be integral to the blade assembly, and such embodiments are already discussed above in relation to FIG. 2. The guard 1000 in FIGS. 10A-10C may be configured to be combinable with a blade assembly 204 that includes an integral longitudinally-extending central member 206 and/or that includes a detachable longitudinally-extending central member 206. It is understood, of course, that the longitudinally-extending central member 206 may be included with the blade assembly 204 or may be provided separately from the blade assembly 204 and combinable therewith to function as the sole guard component.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A guard for a hair removal device, the guard comprising:
opposing first and second lateral end members each defining a lateral surface extending between first and second lateral ends;
at least one longitudinally-extending member arranged between the opposing first and second lateral end members; and
a retaining element arranged on the opposing first and second lateral end members or the at least one longitudinally-extending member to removably retain the guard about a portion of a blade of the hair removal device.

2. The guard of claim 1, wherein the at least one longitudinally-extending member comprises a longitudinally-extending central member extending from a midpoint of the lateral surface of the first lateral end member to a midpoint of the lateral surface of the second lateral end member so as to be adjacent to a top surface of the portion of the blade of the hair removal device, the midpoints of the first and second lateral end members being defined between the respective first and second lateral ends thereof.

3. The guard of claim 2, wherein each of the first and second lateral ends of each of the opposing first and second lateral end members extends down from the respective lateral surface thereof.

4. The guard of claim 3, wherein each of the first and second lateral ends of each of the opposing first and second lateral end members extends down from the respective lateral surface at a substantially 90-degree angle.

5. The guard of claim 3, wherein each of the first and second lateral ends of each of the opposing first and second lateral end members extends down from the respective lateral surface at an angle between about 10 and about 30 degrees.

6. The guard of claim 3, wherein the at least one longitudinally-extending member further comprises first and second longitudinally-extending side members arranged between the opposing first and second lateral end members and on either side of the longitudinally-extending central member such that the first longitudinally-extending side member is arranged between the first lateral ends of the first lateral end member and the second lateral end member and the second longitudinally-extending side member is arranged between the second lateral ends of the first lateral end member and the second lateral end member.

7. The guard of claim 6, further comprising a plurality of spaced-apart teeth arranged on each of the first and second longitudinally-extending side members.

8. The guard of claim 2, wherein the longitudinally-extending central member defines a longitudinal surface offset from the lateral surfaces of the first and second lateral end members, such that the longitudinal surface and the lateral surfaces are not co-planar.

9. The guard of claim 2, wherein the longitudinally-extending central member defines a longitudinal surface co-planar with the lateral surfaces of the first and second lateral end members.

10. The guard of claim 2, wherein the opposing first and second lateral end members each include a rear portion extending down from the lateral surface thereof and between the first and second lateral ends.

11. The guard of claim 10, wherein the retaining element comprises:
a flexible tab defined on the rear portion and arranged to removably engage a corresponding depression in a blade assembly including the blade, and
an opening defined on the lateral surface of each of the opposing first and second lateral end members, the opening being aligned with a corresponding protrusion on the blade assembly,
wherein the flexible tab and the opening retain the guard about the portion of the blade of the hair removal device.

12. The guard of claim 1, wherein the at least one longitudinally-extending member comprises first and second longitudinally-extending side members arranged between the opposing first and second lateral end members such that the first longitudinally-extending side member is arranged between the first lateral ends of the first lateral end member and the second lateral end member and the second longitudinally-extending side member is arranged between the second lateral ends of the first lateral end member and the second lateral end member.

13. The guard of claim 12, further comprising a plurality of spaced-apart teeth arranged on each of the first and second longitudinally-extending side members.

14. The guard of claim 1, wherein the retaining element defines a rib arranged on the first and second lateral ends of each of the first and second lateral end members and that engages a bottom surface of the blade and retains the guard about the portion of the blade of the hair removal device.

15. A hair removal device system comprising:
a hair removal device comprising a blade; and
a guard retainable about a portion of the blade and comprising:
opposing first and second lateral end members each defining a lateral surface extending between first and second lateral ends;
at least one longitudinally-extending member arranged between the opposing first and second lateral end members; and
a retaining element arranged on the opposing first and second lateral end members or the at least one longitudinally-extending member to removably retain the guard about a portion of the blade of the hair removal device.

16. The system of claim 15, wherein the at least one longitudinally-extending member of the guard comprises a longitudinally-extending central member extending from a midpoint of the lateral surface of the first lateral end member to a midpoint of the lateral surface of the second lateral end member so as to be adjacent to a top surface of the portion of the blade of the hair removal device, the midpoints of the first and second lateral end members being defined between the respective first and second lateral ends thereof.

17. The system of claim 16, wherein each of the first and second lateral ends of each of the opposing first and second lateral end members of the guard extends down from the respective lateral surface thereof.

18. The system of claim 16, wherein the at least one longitudinally-extending member of the guard further comprises first and second longitudinally-extending side members arranged between the opposing first and second lateral end members and on either side of the longitudinally-extending central member such that the first longitudinally-extending side member is arranged between the first lateral ends of the first lateral end member and the second lateral end member and the second longitudinally-extending side member is arranged between the second lateral ends of the first lateral end member and the second lateral end member.

19. The system of claim 18, wherein the guard further comprises a plurality of spaced-apart teeth arranged on each of the first and second longitudinally-extending side members.

20. The system of claim 15, wherein the at least one longitudinally-extending member of the guard comprises first and second longitudinally-extending side members arranged between the opposing first and second lateral end members such that the first longitudinally-extending side member is arranged between the first lateral ends of the first lateral end member and the second lateral end member and the second longitudinally-extending side member is arranged between the second lateral ends of the first lateral end member and the second lateral end member.
